(19) United States
(12) Patent Application Publication
(10) Pub. No.: US 2017/0352039 A1
(43) Pub. Date: Dec. 7, 2017

(54) Counterfeit Prevention and Detection of University and Academic Institutions Documents Using Unique Codes

(71) Applicant: Mohammad Isam Malkawi, Dearborn, MI (US)

(72) Inventor: Mohammad Isam Malkawi, Dearborn, MI (US)

(21) Appl. No.: 15/594,615

(22) Filed: May 14, 2017

(51) Int. Cl. G06Q 30/00; G06K 19/06; G06F 21/16; G06K 19/18

(52) U.S. Cl. CPC G06Q 30/0185; G06K 19/18; G06K 19/06187; G06F 21/16; G06K 19/06037; G06F 2221/0737

(57) ABSTRACT

The invention is related to a system that includes an integrated system for online and real-time authentication of documents using uniquely generated codes and the verification of the authenticity of the documents using online verification data identified by the unique codes. The invention contains 3 independent claims.

In this invention, the unique code (3.8) uniquely identifies a document issued by any organization for any type of documents in any part of the world, and uniqueness is guaranteed. The invention also uses another type of code, a 16 hexadecimal digit code (3.7), which is unique across all documents belonging to a single organization. The invention also uses a KAPTCHA code (3.5), which safeguards the document against auto scan and image processing and optical character recognition.

The unique code (3.8) is embedded within a technology convenient for hiding, encrypting and easy readability of the code, which can be one of a quick response (QR) two dimensional code (3.1), a near filed communication tag (NFC) (3.2), an optical medium strip (3.3), a magnetic medium strip (3.4), or a radio frequency RFID tag (3.5).

The system stores the Meta data of the document (3) which is used to generate the codes as well as the generated codes themselves and a PDF file of the document (3) and/or a photocopy of the document (3) in a secure server for verification purposes.

The verifier (4) can verify the authenticity of the document by either scanning the QR code (3.1) or the NFC tag (3.2) or the optical strip (3.3) or the magnetic strip (3.4) or the RFID tag (3.5) using a special application and submits the code hidden within the QR, NFC, optical strip, magnetic strip, or RFID to the verification server. Alternatively, the verifier (4) can use the 16 hexadecimal digit code (3.7) to access the verification server and performs the verification.

The verification server presents to the verifier all information necessary to establish the authenticity and validity of the document.

Besides authentication, verification, and counterfeit prevention and detection, the invention is also a method for tracing the verified documents based on identity, and location of the verifier.

### TECHNICAL FIELD

The invention is a unique digital system in an integrated process that initially prevents counterfeiting of any document issued through our system by any public organization, academic institution, as well as all official and private offices; it also allows for an efficient, effective and fast online turnaround time for authentication and verification of records.

### CURRENT USED TECHNIQUE

Currently, official certificates and documents are issued by academic institutions, government offices and private organizations for a particular person or purpose with a manual stamp, signature or print. For example, certificates and diplomas are issued for students; license documents are issued for businesses, companies etc., passports and personal ID's are issued for particular persons.

The validity of the certificates and documents issued are authenticated with wet signature, stamp, holograms, ultra violet light, print, and other security marks. Generally, these techniques are good for protecting the medium of the document, and cannot be used to protect the data contained within the document medium. Therefore, such methods cannot prevent counterfeiting of the information carried by the document medium such as the papers and certificates.

Under current systems, current issued documents, with simple tools, can easily be falsified. For example, ID documents, land registry certificates, vehicle licenses and diplomas issued by the academic institutions and organizations are falsified by altering names and grades, validity dates in power of attorney attested by the notary, laboratory analysis results etc. These alterations may not be recognized or identified by the institutions or organizations where such documents are used. Also, cancelled or expired documents to which annotation is attached may not be determined. For example; a document which is attached an annotation after being issued pursuant to the directives may be submitted to and accepted by the organizations and institutions. In the meantime the current process of Authentication and Verification is time consuming, costly and difficult, because quite often it requires direct contact with the institutions or organization which issued the document.

These types of falsification and fraud cause serious moral, material and financial damages. For example; healthcare services provided to the people with a forged medical diploma may lead to many material and moral damages. Another example is tax-ovation and loss of government income due to falsified analysis of chemical material to be imported. Millions of dollars are lost due to falsified documents in addition to public endangerment and waste of time and money in the process of authentication.

At the moment, counterfeiting cannot be prevented because the falsifications made on these documents cannot be easily or quickly detected by institutions or organizations requesting the documents. Currently, the organization requesting the document may authenticate the document on the system if the organization issuing the document permits. For example, when a student submits his credentials to a hiring company, the verification of the authenticity of the provided credentials may take several weeks, cost 100's of dollars, and quite often is not accurate or trustworthy due to the involvement of a human factor in the verification process. Furthermore, specific data on the credentials such as grades of courses are rarely verified, and the verification is only made for the degree as a whole.

In conclusion, due to the unfavorable circumstances described above and insufficient solutions available, it is required to establish a system to prevent and easily detect counterfeiting of data in certificates and documents by controlling validity and authentication in a fast, accurate and precise method. The proposed invention utilizes unique code technique to protect the document against counterfeit and to allow easy, fast, and accurate verification of the document.

### SHORT DESCRIPTION OF INVENTION

The invention is a unique digital system and a process that is lean, fast, reliable, effective in producing safe documents that cannot be falsified and easily authenticated anytime and anywhere in the world.

The invention provides a novel technology for preventing falsification of documents data by providing an integrated process for the authentication and verification of documents such as those produced by academic institutions and potentially by government and private organizations. The method combines the recent technology advances in coding theory, communications, smartphones and cloud computing. Examples of documents to be authenticated using the proposed technology include certificates, transcripts, student identifications and can be extended to licenses, food and medicine certificates, insurance ID cards, reimbursement forms and many other document types.

Primary aim of the method is preventing the issuance of fraudulent documents and detection of any fraudulent document where counterfeit is committed against the document's' data after the issuance of a document. The invention will detect several types of counterfeit including
1—A counterfeit document, which was never produced by the organization claimed to be the origin of the document
2—A counterfeit made against the data contained in the document after the issuance of the document by the organization claimed to be the source of the document
3—A counterfeit made to the electronic data stored on a server and used for the verification of the authenticity of the document
4—A counterfeit made simultaneously to both the electronic data stored on the server and to the data in the document.

Each certificate or document is protected incomparably with a unique electronic code associated with each invariable document. This unique code is;
I. Unequalled and unrepeatable as it is generated by a variable algorithm.
II. Assigned to the document automatically at the time of issuing the document.
III. Used invariably for the verification of the document authenticity.
IV. Validity and authenticity of the document is detected using the unique code assigned to the document (authentication ID).
V. The unique code is embedded in one of several forms, including
   a. Quick Response (QR) code for easy readability, hiding, and encryption
   b. Near filed communication tags (NFC) for reliability, security, and prevention of copying
   c. Radio Frequency identification (RFID) passive tag for reliability, security, and remote readability.
   d. Magnetic medium strip
   e. Optical medium strip

With the use of this unique code, the method in our invention reduces counterfeit in documents and certificates to zero.

Another embodiment of the invention is to enable any organization wanting to verify the authenticity of the document to read the authentication ID, decrypt it and retrieve from a predetermined server all information necessary to establish the authenticity of the document.

A different embodiment of the invention is to grant the organization which issued the document to obtain control over the validity of the document after it has been issued. An example of the control includes cancelling a document for a pre-specified reason. Another example is controlling the expiration date of the document. A third example is the inclusion of annotation to the document for any reason.

The invention has a wide range of benefits for individuals as well as for organizations and the community and some of the benefits are described below:

### BENEFITS FOR THE ORGANIZATION ISSUING THE DOCUMENT

The invention has the following benefits for the organizations and academic institutions issuing documents as well as all official and private organizations:
I. Increased confidence and trust in the document produced by the organizations
II. Reduces the loss resulting from the fraud of documents
III. Easy, simple and fast verification of the documents issued by the organizations
IV. Ability to invalidate and revalidate any documents using the unique code associated with documents issued by the organizations (Authentication ID)
V. Ability to collect and analyze statistics about the documents issued by the organizations and verified by other organizations
VI. Reducing cost incurred due to the need to respond to various entities requiring the verification of the documents issued by the organizations

### BENEFITS FOR BEARER OF THE DOCUMENT

The bearer of the documents such as diplomas, school graduation certificates, real estate certificates and other types of documents will have the following benefits:
I. No other person can compete with him/her using a fraudulent document
II. Reduced time for the verification of his/her document by various institutions and organizations for verification of the document (in some cases, verification of a document may last for weeks)
III. Reduced cost of verification process, as verification is performed instantly.
IV. Reduced back and forth communication cycle between the original institute and the organization wanting to verify the document
V. Reliable authentication of documents, especially during crisis, wars and abnormal conditions where original source of documents cannot be reached easily

### BENEFITS FOR THE VERIFIER OF THE DOCUMENT

Verifying organizations, academic institutions and all government and private institutions and organizations, real and legal entities shall have the following benefits:
I. Easy and fast verification of the document, which reduces the time required to verify a certain document
II. Detection of any cancelled, expired documents or documents attached annotation for any reason
III. Reliable verification is possible at any time and place
IV. Reduced cost of verification by removing the cost of intermediary services such as mail and courier institutions
V. Reducing the human errors made intentionally or by mistake
VI. Increased trust in verified documents
VII. Creating a national or international document authentication network by generalizing the method of invention (For example; a document issued in a country may be easily inquired and verified in another country without any requirement for any institution of organization in between)

### BENEFITS FOR THE COMMUNITY

The invention provides the community with an advanced technology and contributes to the wellbeing and security of people with the following benefits:
I. Reduced rate of fraudulent documents worldwide
II. Preventing global cost of fraud in documents which is estimated by 100's of billions of dollars by the experts
III. Removing unfavorable conditions resulting from the holders of fraud documents

Structural specifications and characteristics as well as all benefits shall be well understood thanks to the detailed explanations and figures and referral to the figures and therefore it is necessary to make the assessment based on these figures and detailed explanations.

### FIGURES TO HELP UNDERSTAND THE INVENTION

Our invention “Counterfeit prevention and detection of University and Academic Institutions Documents Using Unique Codes”, subject to the application is shown with the figures attached as the following;

FIG. 1: It is the illustration of the system (1) regarding “Counterfeit prevention and detection of University and Academic Institutions Documents Using Unique Codes” subject to the invention.

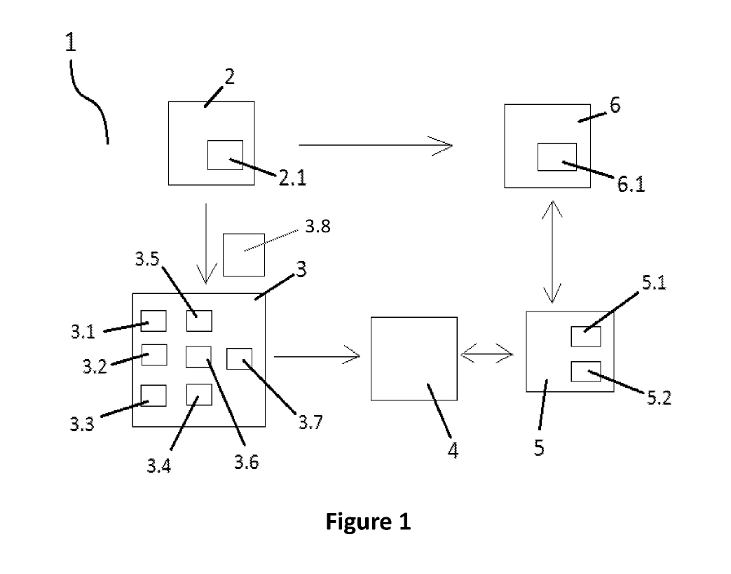

FIG. 2: It is the illustration of a document (3) including QR code (3.1) and 16 hexadecimal digit code (3.7) regarding “Counterfeit prevention and detection of University and Academic Institutions Documents Using Unique Codes”, subject to the invention.

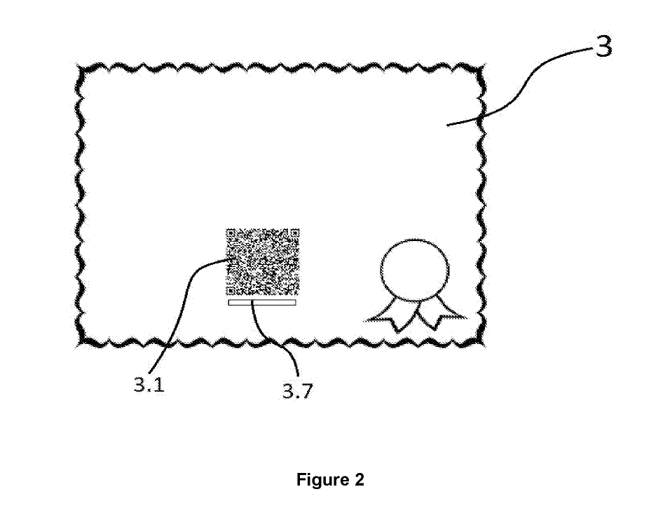

FIG. 3: It is the authentication process diagram of the system (1) regarding “Counterfeit prevention and detection of University and Academic Institutions Documents Using Unique Codes”, subject to the invention.

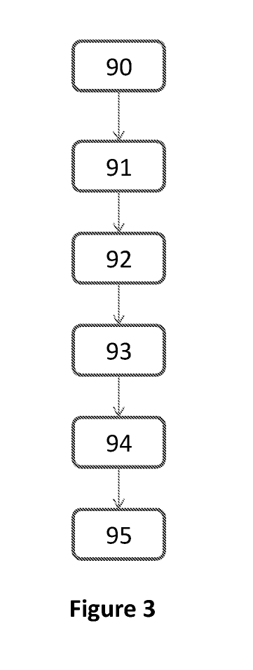

FIG. 4: It is the verification process diagram of the process steps regarding “Counterfeit prevention and detection of University and Academic Institutions Documents Using Unique Codes” including the generation of the unique code (3.5), the verification code (3.6) and the 16 hexadecimal digit code (3.7) and attaching the document (3).

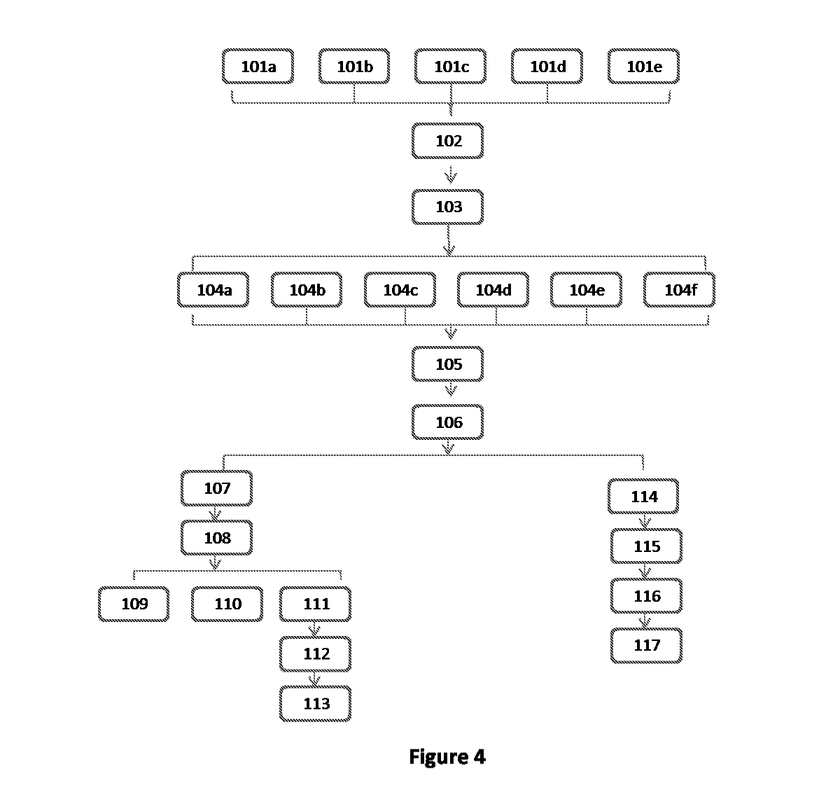

“As the drawings in the figures are representations, they are to be scaled. The details not required to understand the invention may have been ignored. Apart from that, identical elements or elements with identical functions are illustrated with the same number.”

### DESCRIPTION OF PARTS

Our invention of “Counterfeit prevention and detection of University and Academic Institutions Documents Using Unique Codes”, is enumerated in the figures attached and the names of corresponding parts are as the following;

Components of the System FIG. (1)
1. System
2. Document issuer
   2.1 Server 1
3. Document

Unique document identification code embedded in one of the following forms:
3.1 QR code
3.2 NFC (near field communication)
3.3 Optical medium strip
3.4 Magnetic medium strip
3.5 RFID Tag

Redundant codes for added security:
3.6 Unique 5 digit CAPTCHA code
3.7 Hexadecimal 16 digit Code
4. Verifier
5. Verification Device
   5.1 Web site
   5.2 Smart phone Application
6. Storage and Verification
   6.1 Server 2

Components of FIG. (2)

3. An example of a document (3) subjected to authentication using QR embedded code (3.1)

3.1 QR code (3.1) used for storing and hiding the unique code generated for the document (3).

3.7 The 16 digit hexadecimal code used for accessing the document data on server 2 (6.1) via the website (5.1) on verification device 5.

### DESCRIPTION OF PROCEDURE STEPS FOR AND AUTHENTICATION AND VERIFICATION

Our invention subject to this application is headed as “”A system for counterfeit prevention and detection using authentication and verification with unique codes in documents and certificates” and enumerated in the figures attached and the process steps are explained as the following.

FIG. (3): Process Steps Regarding the Operation of the System (1) and the Authentication Process as Shown in FIG. (3):
90. Document issuer (2) must submit meta data of the document (3) to code supplier service application in Server 1 (2.1) through secure communication and network tools while document (3) is being produced and request the unique codes (3.6) and (3.7) and (3.8) for document (3)
91. The unique code (3.8) consists of two independently generated and highly randomized codes, one is related to the meta data of the document (3), and the other is related to the source of document, i.e., document issuer (2)
92. The highly randomized generated unique code (3.8) is placed in the document (3) and integrated with the QR code (3.1), or alternatively NFC (near field communication) (3.2), or alternatively optical medium strip (3.3) or alternatively magnetic medium strip (3.4) or alternatively radio frequency identification RFID (3.5).
93. The highly randomized 16 hexadecimal digit code (3.7) is placed on the document (3) in a visible format next to the code (3.8) embedded within (3.1) or (3.2) or (3.3) or (3.4) or (3.5). The code (3.7) is used for verification of the document (3) over the web site (5.1).
If the code supplier service fails to read the QR Code (3.1), NFC (near field communication) (3.2), optical medium strip (3.3), magnetic medium strip (3.4), or RFID (3.5) for any reason, then code (3.7) can be manually entered into the web site (5.1) to verify the document (3).
94. The Code supplier service application generates a verification CAPTCHA code (3.6) consisting of 5 random characters/digits with the unique code (3.8) and the 16 hexadecimal digit code (3.7). The CAPTCH code (3.6) is used to prevent one specific form of counterfeit using high capability optical reader recognition (OCR) capability.
95. After the document issuer (2) receives all the codes generated for the document (3), and affixes them to the document in a pre-specified format, then a PDF file and/or a photo copy of the document (3) is generated and subsequently the PDF file and/or the photo copy, the Meta data and the generated codes are stored in the data base of the Server 2 (6.1).

FIG. (4): Process Steps Regarding the Operation of the System (1) and the Verification Process as Shown in FIG. (4):
101a. Document issuer (2), issues the document (3) with a unique code pertinent to the information obtained from the document (3) and include it in a QR code form (3.1) as required by a real or legal entity in server 1 (2.1) and delivers a copy of the document (3) to the server 2 (6.1) of the storage and verification (6) server,
101b. Alternatively, document issuer (2), issues the document (3) with a unique code pertinent to the information obtained from the document (3) and include it in a NFC (3.2) as required by a real or legal entity in server 1 (2.1) and delivers a copy of the document (3) to the server 2 (6.1) of the storage and verification (6) server,
101c. Alternatively, document issuer (2), issues the document (3) with a unique code pertinent to the information obtained from the document (3) and include it in an optical medium strip (3.3) as required by a real or legal entity in server 1 (2.1) and delivers a copy of the document (3) to the server 2 (6.1) of the storage and verification (6) server,
101d. Alternatively, document issuer (2), issues the document (3) with a unique code pertinent to the information obtained from the document (3) and include it in an magnetic medium strip (3.4) as required by a real or legal entity in server 1 (2.1) and delivers a copy of the document (3) to the server 2 (6.1) of the storage and verification (6) server,
101e. Alternatively, document issuer (2), issues the document (3) with a unique code pertinent to the information obtained from the document (3) and include it in an RFID (3.5) as required by a real or legal entity in server 1 (2.1) and delivers a copy of the document (3) to the server 2 (6.1) of the storage and verification (6) server,
102. Document issuer (2) delivers the real or legal entity to the printer of the document (3)
103. Real or legal entity submits the document (3) to the verifier (4)
104a. The verifier (4) scans the QR code (3.1) using the application (5.2) in the device (5) and inquires the validity and verification of the document (3)
104b. Alternatively, the verifier (4) scans the NFC (3.2) using the application (5.2) in the device (5) and inquires the validity and verification of the document (3)
104c. Alternatively, the verifier (4) scans the optical medium strip (3.3) using the application (5.2) in the device (5) and inquires the validity and verification of the document (3)
104d. Alternatively, the verifier (4) scans the magnetic medium strip (3.4) using the application (5.2) in the device (5) and inquires the validity and verification of the document (3)
104e. Alternatively, the verifier (4) scans the RFID tag (3.5) using the application (5.2) in the device (5) and inquires the validity and verification of the document (3)
104f. Alternatively, the verifier (4) of the document (3) may use the application (5.2) in the device (5), where the verifier uses the web site (5.1) and enters the 16 hexadecimal digit code (3.7) on the document (3) to perform the verification
105. Unique code obtained from (3.1) or (3.2) or (3.3) or (3.4) or (3.5) is submitted through the application (5.2) or alternatively the hexadecimal digit code (3.7) written in the web site (5.1) is submitted to server 2 (6.1) owned by the storage and verification (6) over internet
106. Server 2 (6.1) of the storing and verifying organization analyses the unique code obtained from (3.1) or (3.2) or (3.3) or (3.4) or (3.5) or alternatively the 16 hexadecimal digit code (3.7) submitted and matches the unique codes in the database storage at server 2 (6.1).
107. If the unique code obtained from (3.1) or (3.2) or (3.3) or (3.4) or (3.5) or the 16 hexadecimal digit code (3.7) is matched with the corresponding unique code in the data base of the storage and verification (6) server; then the verification data is submitted to the application (5.2) or website (5.) in the device (5) of the verifier (4) from Server 2 (6.1).
108. The verification data, otherwise referred to as the Meta Data, is compared with the Meta data available on the application (5.2) in the device (5) or web site (5.1)
109. If Meta Data does not match; then the document (3) is declined and a fraud attempt is declared and recorded by the verifier in an appropriate place
110. If the Meta data does match; the document (3) is verified and validity of the Meta Data of document (3) is authenticated
111. In order to establish the complete authenticity of document (3), and verify the non Meta Data of document (3), the verifier (4) demands a photo copy or a PDF version of the document (3) from server 2 (6.1) over the application (5.2) or the web site (5.1). The non Meta Data includes the document (3) fixed data such as the name of the organization, the logo, the signatures, the stamps, and the like.
112. The photo copy or PDF version of the document (3) is submitted to the Server 2 (6.1) during the initial issuance of the document (3).
113. The verifier (4) compares the photo copy or PDF file of document (3) as obtained from serve 2 (6.1) with the document (3) available at hand for verification. If any discrepancy is found, then document (3) is considered a counterfeit.
114. If the data submitted to the storage and verification (6) does not match with the data in the documents (3) in the database of the storing and verifying organization, the document (3) is declined and then a fraud attempt is declared and recorded in the appropriate place
115. If the code obtained from (3.1) or (3.2) or (3.3) or (3.4) or (3.5) or the 16 hexadecimal digit code (3.7) is not matched with a corresponding code in the database of server 2 (6.1), then the document (3) is declared a counterfeit.
116. If the code obtained from (3.1) or (3.2) or (3.3) or (3.4) or (3.5) or the 16 hexadecimal digit code (3.7) does match a corresponding code in the database of server 2 (6.1), then the Meta Data of the corresponding code is used to reproduce the corresponding unique code using the same algorithm which was used to produce the unique code at the time of issuing the document.
117. If the newly generated code in step #116 above does not match the unique code stored in the database and the unique code obtained from (3.1) or (3.2) or (3.3) or (3.4) or (3.5) or the 16 hexadecimal digit code (3.7) then a counterfeit is declared against the data stored in the database.
118. Steps #116 and #117 are used to detect a counterfeit case, where both the physical document (3) and the electronic document stored on server 2 (6.1) have been subject to a counterfeit attempt.

### DETAILED DESCRIPTION OF THE INVENTION

These details are intended for providing a better understanding of the invention “Counterfeit prevention and detection of University and Academic Institutions Documents Using Unique Codes”, without any limitation.

Besides, some elements or process steps prepared for better understanding of the invention may have been used differently in order to provide content integrity. The elements or process steps actually represent the relevant element or process steps enumerated the same.

System (1) subject to the invention includes:
Document issuer (2) including Server 1 (2.1) and providing issuance of the document (3),
The document (3) including any of the following items
   QR code (3.1) hiding the unique code (3.8), verification code (3.6) in meta data and the 16 hexadecimal digit code (3.7)
   NFC (near field communication) (3.2) hiding the unique code (3.8), verification code (3.6) in meta data and the 16 hexadecimal digit code (3.7)
   Optical medium strip (3.3) hiding the unique code (3.8), verification code (3.6) in meta data and the 16 hexadecimal code (3.7)
   Magnetic medium strip (3.4) hiding the unique code (3.8), verification code (3.6) in meta data and the 16 hexadecimal code (3.7)
   RFID tag (3.4) hiding the unique code (3.8), verification code (3.6) in meta data and the 16 hexadecimal code (3.7)
Verifier (4) of the document receives the document (3) submitted by a real/legal entity and verifies the authenticity and validity of the document (3) using online data obtained from server 2 (6.1).
Device (5) including the mobile application (5.2) or providing access to the web site (5.1) with secure communication protocols.
Storage and verification (6) having Server 2 (6.1) which is connected online to the document issuer (2) and verifier (4)

Document issuer (2) includes Server 1 (2.1) and generates the document (3). The document issuer (2) is the party wanting to issue the document (3) and authenticate it online and in real-time by using the proposed system (1). Document issuer (2) may be any academic institutions or organizations, real or legal entities with the authorization to issue a document (3). The document issuer (2) must have a Server 1 (2.1) with secure connection to the internet.

A document (3) may be prepared in five different ways. Also, as far as technically feasible, this document (3) may be prepared in other ways. The document (3) includes certificates, transcripts, and student identifications and can be extended to licenses, food and medicine certificates and many other document types. Five ways by which the document (3) is formed are described as the following;

One includes QR code (3.1) hiding the unique code (3.8), verification code (3.6) placed in the Meta data (3.6) and the 16 hexadecimal digit code (3.7) placed next to the QR code (3.1).

Another one includes NFC (near field communication) (3.2) hiding the unique code (3.8), verification code (3.6) placed in the Meta data and 16 hexadecimal digit code (3.7) placed next to the NFC tag (3.2).

The third one includes optical medium strip (3.3) hiding the unique code (3.8), verification code (3.6) placed in the Meta data and 16 hexadecimal digit code (3.7) placed next to the optical medium strip (3.3).

The fourth one includes magnetic medium strip (3.4) hiding the unique code (3.8), verification code (3.6) placed in the Meta data and 16 hexadecimal digit code (3.7) placed next to the magnetic medium strip (3.4).

The fifth one includes RFID tag (3.5) hiding the unique code (3.8), verification code (3.6) placed in the Meta data and 16 hexadecimal digit code (3.7) placed next to the RFID tag (3.5).

The document (3) may be issued in one of the above five ways. It is of paramount importance to note that none of the five different ways carries any information other than the codes (3.7) and (3.8), which constitute the only vehicle to retrieve the verification information online from server 2 (6.1).

The unique code (3.8) is a highly randomized unique code (3.8) generated by the code supplier service with a special hashing function for each document (3). The unique code (3.8) is generated by using the Meta data of the document (3). The unique code (3.8) is 88 characters in length and guaranteed to be unique across all organizations using the system (1).

In the same manner, the 16 hexadecimal digit code (3.7) is generated using another hashing function. This code is guaranteed to be unique within the organization issuing the document.

The verification code (3.6), is a randomly generated 5 digit/character generated randomly and is not required to be unique across all documents.

The Meta data used to generate the unique code (3.8) and (3.7) for the document (3) includes the following:
a. The date and time of generating the code for the document (3)
b. Type of document (3) (certificate, diploma, letter, etc.)
c. Name of the organization (2) issuing the document (3)
d. Information about the entities eligible to receive, verify and validate the document (3) such as “Any: means any entity without restriction”, “Except: means any entity except the specified ones”, Specific: means only the specified entities”.
e. Information about type of paper being used to issue the document (3) (weight, dimensions, color)
f. Location (GPS) information about the place where the document (3) is issued
g. Special marks
h. Information about the entity receiving the documents including but not limited to name, personal identification number, social security number, birthday, and other relevant information.

Unique code (3.8) is hid in the QR code (3.1), NFC (near field communication) (3.2), optical medium strip (3.3), magnetic medium strip (3.4), or RFID tag invisibly.

Verification code (3.6) includes 5 random characters/digits in code supplier service and it is hidden in Meta data. Verification code (3.6) is generated together with the unique code (3.8) and the 16 hexadecimal digit code (3.7). The verification code (3.6) is augmented with noise before adding it to the document (3). Verification code (3.6) is attached to the document (3) in order to prevent electronic code deciphering by using optical character reader or image processing software.

The 16 hexadecimal digit code (3.7) is placed on the document (3) visibly. The aim of placing the 16 hexadecimal digit code (3.7) on the document (3) is that it only allows the entity inquiring the document (3) or the organizations to go further by writing it one by one on the web site (5.1)

The verifier (4) is the person or organization that verifies the authenticity of the document (3) or whether it is falsified. The verifier (4) carries out this process via the device (5). The device (5) in question may be any electronic device such as computers, smart phones, tablet pc or any device that operates the system (1) with secure connection to the internet.

The device (5) is an electronic device attached to the internet providing access to the web site (5.1) and including an application (5.2) such as computers, smart phones, tablet pc or any device that operates the system (1) with secure connection to the internet.

The web site (5.1) in our invention is any internet platform where the users can initiate and request authentication process. The users may verify the document (3) on the web site (5.1) provided they use the 16 hexadecimal digit code (3.7).

The application (5.2) is a software designed to carry out document (3) verification process in any electronic device (5) such as computers, smart phones, tablet pc or any device that operates the system (1). Using the application (5.2), the users may carry out verification process with the camera, QR Code (3.1) scanner optical reader of the device (5) or the NFC reader or the RFID reader or magnetic strip reader.

Storage and verification (6) includes Server 2 (6.1). Storage and verification (6) server includes verification data for the documents (3) received from the issuing organization (2) or the person and it includes unique code (3.8) of the authenticated documents (3), the 16 hexadecimal digit code (3.7) and the verification code (3.6).

In addition, storage and verification (6) server controls the authenticity and validity of the document by comparing the data such as the unique code (3.8), the 16 hexadecimal digit code (3.7) and the verification code (3.6) with the ones in its database.

Our invention has software that carries out all process steps which include code supplier service, authentication of document (3), verification of the authenticity of the document, and the integrity of the data stored on the database.

Mode of Operation of the Proposed System (1):

If a document (3) having a QR code (3.1) is issued, the issuing organization, institution, real or legal entities (2) issue the document (3) with a QR code (3.1) required by the real or legal entity in server 1 (2.1) and submits a copy of the document (3) to the storage and verification (6) Server 2(6.1)

If a document (3) having a NFC (3.2) is issued, the issuing organization, institution, real or legal entities (2) issue the document (3) with a NFC (3.2) required by the real or legal entity in server 1 (2.1) and submits a copy of the document (3) to the storage and verification (6) Server 2(6.1)

If a document (3) having an optical medium strip (3.3) is issued, the issuing organization, institution, real or legal entities (2) issue the document (3) with an optical medium strip (3.3) required by the real or legal entity in server 1 (2.1) and submits a copy of the document (3) to the storage and verification (6) Server 2(6.1)

If a document (3) having a magnetic medium strip (3.4) is issued, the issuing organization, institution, real or legal entities (2) issue the document (3) with a magnetic medium strip (3.4) required by the real or legal entity in server 1 (2.1) and submits a copy of the document (3) to the storage and verification (6) Server 2(6.1)

If a document (3) having an RFID tag (3.5) is issued, the issuing organization, institution, real or legal entities (2) issue the document (3) with an optical medium strip (3.3) required by the real or legal entity in server 1 (2.1) and submits a copy of the document (3) to the storage and verification (6) Server 2(6.1)

The organization, institution, real and legal entity issuing the document (2) gets the print out of the document (3) and delivers it to the real or legal entities. The real and legal entities then deliver the document (3) to the verifier (4) of the document.

If the document (3) has a QR code (3.1), Verifier (4) reads the QR code (3.1) through the application (5.2) in the device (5) and controls validity and authenticity of the document (3).

If the document (3) has a NFC (3.2), Verifier (4) reads the NFC (3.2) through the application (5.2) in the device (5) and controls validity and authenticity of the document (3).

If the document (3) has an optical medium strip (3.3), Verifier (4) reads the optical medium strip (3.3) through the application (5.2) in the device (5) and controls validity and authenticity of the document (3).

If the document (3) has a magnetic medium strip (3.4), Verifier (4) reads the magnetic medium strip (3.4) through the application (5.2) in the device (5) and controls validity and authenticity of the document (3).

If the document (3) has a RFID tag (3.5), Verifier (4) reads the RFID tag (3.5) through the application (5.2) in the device (5) and controls validity and authenticity of the document (3).

If the verifier (4) cannot use the application (5.2) in the device (5) for any reason, it can log into web site (5.1) through the device (5) and write the 16 hexadecimal digit code (3.7) on the document (3)

In the meantime, the system (1) delivers the unique code (3.8) generated through the application (5.2) or submits the 16 hexadecimal digit code (3.7) written on the web site (5.1) to the storage and verification (6) Server 2 (6.1)

At this stage, the storage and verification (6) Server 2 (6.1) analyzes the unique code (3.8) received and matches the unique codes (3.8) in the database.

If there is a match between the unique codes (3.8) submitted to the server storage and verification (6) and the unique code (3.8) in the data base of the storage and verification (6), then an integrity check is performed:

The meta data on the server is used to regenerate the unique code (3.8) or the 16 hexadecimal digit code (3.7), and a comparison is made between the received unique code (3.8) and/or the 16 hexadecimal digit code (3.7) with the recently generated unique code (3.8) and/or 16 hexadecimal digit code (3.7). If a mismatch is detected, then a fraud attempt is declared, and the document (3) is rejected. This type of fraud is made to the document (3) and to the Meta data on the server. This type of counterfeit generates an alert to warn the system maintainer to switch to a standby system. If no mismatch is found, the system (1) proceeds to the next step.

If there is a match between the unique codes (3.8) submitted to the server storage and verification (6) and the unique code (3.8) in the data base of the storage and verification (6), and the unique code (3.8) generated at the time of verification then the relevant Meta data is delivered to the application (5.2) in the device (5) of the verifier (4) or to the web site (5.1).

The received Meta data is delivered to the web site (5.1) or application (5.2) in the device (5). The received Meta data is compared with the Meta data presented by the document (3) under verification. If a mismatch is found in the Meta data the document (3) is declined and a fraud attempt is declared and recorded in an appropriate place.

If the Meta data match, the document (3) is verified and authenticity of the Meta data is established.

A second level of verification can be carried out by the verifier (4), which aims at establishing the authenticity of the entire document (3) including the titles, logos, signatures, stamps, and other information. The verifier (4) must request the PDF version of the document (3) or its photo copy over the application (5.2) or the web site (5.1). The PDF version of the document (3) or its photo copy submitted to the Server 2(6.1) during the initial issuance of the document(3), is delivered to the application (5.2) in the device (5) or web site (5.1) from the Server 2 (6.1). Now, the verifier(4) organization or entity can compare PDF file with the document (3) under verification.

If a mismatch is detected between the data found in the document (3) and the data obtained from the PDF version of document (3) or its photo copy as received from server 2 (6.1), then the document (3) is declined and then a fraud attempt is declared and recorded in the appropriate place.

Steps of Generating the Unique Code (3.8), the Verification Code (3.6) and the 16 Hexadecimal Digit Code (3.7) Used in Our System (1) and Adding the Codes in the Document (3):

Document issuer (2) must submit meta data of the document (3) to code supplier service application in Server 1 (2.1) through secure communication and network tools while document (3) is generated and must request the unique codes (3.6) and (3.7) and (3.8).

Code supplier service application generates the unique code (3.8) consisting of two codes, one is related to the Meta data of the document (3), and the other is special data pertaining to the issuer of the document (3) issuer (2).

The unique code (3.8) generated is placed in the document (3) and integrated with the QR code (3.1), NFC (near field communication) (3.2), optical medium strip (3.3), magnetic medium strip (3.4), or RFID tag (3.5).

The code supplier server 1 (2.1) generate the verification code (3.6) and the 16 hexadecimal digit code (3.7) and submits them to the document issuer (2).

In order to compensate for the case, where the code supplier service fails to read the QR Code (3.1), NFC (near field communication) (3.2), optical medium strip (3.3), magnetic medium strip (3.4), or RFID tag for any reason, the 16 hexadecimal digit code (3.7 is supplied to the issuer (2) so that code (3.7) may be used for verification of the document (3) over the web site (5.1). Code (3.7) is generated together with the unique code (3.8) and the 16 hexadecimal digit code (3.7) is placed on the document (3) in a visible format next to the (3.8) code.

Code supplier service application generates a verification code (3.6) consisting of 5 random characters/digits with the unique code (3.5) and the 16 hexadecimal digit code (3.7).

After the document issuer (2) receives and matches the codes generated for the document (3), a PDF file and/or a photo copy of the document is generated for the valid document (3) and the PDF file and/or photo copy of the document (3), the Meta data used for the generation of codes, and the generated codes are stored in the data base of the Server 2 (6.1).

The verification 5 character/digit code (3.6) is used to prevent one type of counterfeit procedure. In this case, the counterfeiter enforces the use of an application other than the ones supplied as in device 5 (5.1) and (5.2). The counterfeit application would use a highly sophisticated image processing applications to process the document (3) and generate new Meta data after applying forgery to the data. This process will be prohibited by applying a the 5 character/digit in a noisy form, which will cause the counterfeit process to fail.

This process requires the use of applications other than the ones supplied by the system of the current invention. However, the use of the CAPCHA (noisy code) (3.6) will render this operation unuseful.

1. The invention is a system (1) that is used for online and realtime authentication and verification of the documents and prevents counterfeiting the documents issued by the organizations and academic institutions as well as all public and private organizations and detects a cancelled, expired documents or documents attached annotation for any reason by using a unique code (3.8) or (3.7) in an integrated process and it includes:
The server 1 (2.1) and document issuer (2) that issues the document (3),
The document (3) having the unique code (3.8) and the 16 hexadecimal digit unique code (3.7) and the verification code (3.6)
The code (3.8) is 88 characters long code and must be embedded within:
Quick Response code (3.1)
Near field Communication tag (NFC) (3.2)
Optical medium strip (3.3)
Magnetic medium strip (3.4)
Radio frequency identification (3.5)
In all further steps and embodiments we shall assume the use of the QR code (3.1) to further illustrate the claims without loss of generality.
The 16 hexadecimal digit code (3.7) is a code unique for all documents within the organization and is placed on the document in a visible form and is used as an alternative method for the verification of the document (3).
The verification 5 digit code (3.6) is provided in skewed noisy font, in order to prevent a robotic scan of the document data and electronic code analyzing by using an optical reader or image processing software
The verifier (4) receiving the document (3) submitted by the real or legal entity and detecting validity and authenticity of the document (3),
The device (5) providing Access to the web site (5.1) or having a mobile application (5.2),
Storage and verification (6) including Server 2 (6.1) interacting with the document issuer (2) and verifier (4).
The system must have a secure connection to the internet during authentication and verification of the document (3).

2. It is the system (1) in claim 1, which means document issuer (2) has a code supplier service application program interface (API).

3. It is the system (1) in claim 1, which includes generating a document (3) in code supplier service having a special hashing function for each document (3) with unique codes (3.8) and (3.7) and code (3.6).

4. It is the system (1) in claim 1 which includes a 16 hexadecimal digit code (3.7) that enables the verifying entity or organizations (4) to verify the document over the web site (5.1) by writing the characters one by one.

5. It is the system (1) in claim 1, which includes an electronic device (5) such as computers, smart phones, tablet pc or any device that operates the system (1) providing access to the web site (5.1) and including a mobile application (5.2)

6. It is the system (1) in claim 1, which includes storage and verification (6) server which stores the digital documents (3) received by the issuing organization (2) or the person and unique code (3.8) of these documents (3), the 16 hexadecimal digit code (3.7) and verification code (3.6).

7. The invention is the verification method of a system (1) that is used for the verification of the documents with a unique code (3.8) and (3.7) and (3.6) and prevents counterfeiting the documents issued by the organizations and academic institutions as well as all public and private organizations through an integrated online and real-time process and it includes the steps below.
claim #7 is independent claim
Document issuer (2), issues the document (3) with a QR code (3.1) (or NFC tag (3.2) or optical medium strip (3.3) or magnetic medium strip (3.4) or RFID tag (3.5)) as required by a real or legal entity in server 1 (2.1) and delivers an copy of the document (3) to the server 2 (6.1) of the storage and verification (6) (101a),
Document issuer (2) delivers the real or legal entity the printout of the document (3) (102),
The real or legal entity submits the document (3) to the verifier (4) (103) for verification,
The verifier (4) scans the QR code (3.1) in the application (5.2) in the device (5) and inquires the validity and verification of the document (3) (104a),
The unique code (3.8) is extracted from the QR code (3.1) using the application (5.2) on device (5) and is subsequently submitted by the application (5.2) to server 2 (6.1) through a secure internet connection,
Alternatively, the 16 hexadecimal digit code (3.7) on is written manually in the web site (5.1) and is submitted to server 2 (6.1) through a secure internet connection,
Server 2 (6.1) of the storing and verifying organization analyses the received unique code (3.8) and searches for a match of the unique codes (3.8) in the database (106),
Alternatively, server 2 (6.1) of the storing and verifying organization analyses the received unique code (3.7) and searches for a match of the unique code (3.7) in the database (106),
If the server (2) finds a match for the unique code (3.8) or the unique code (3.7) in the data base of the storage and verification (6) then the document (3) is recognized as an official document produced by issuer (2), and will be subject for further investigation.
Alternatively, if the server (2) does not find a match for the unique code (3.8) or the unique code (3.7) in the data base of the storage and verification (6) then the document (3) is recognized as an illegal and unofficial document and not produced by issuer (2), and will be subject for counterfeit investigation
A further embodiment, if the server (2) finds a match for the unique code (3.8) or the unique code (3.7) in the data base of the storage and verification (6), then the server (2) will locate the Meta data, which was used to generate the codes (3.8) and (3.7), and will use the same algorithms which were originally used to generate the codes (3.8) and (3.7) and will regenerate the codes (3.8) and (3.7) using the same algorithms.
A further embodiment of the previous bullet, the server (2) will compare the received codes (3.8) and (3.7) from device (5) with the newly generated codes (3.8) and (3.7) at the server (2). If the two codes (3.8) do not match or the two codes (3.7) do not match, then a counterfeit attempt against the electronically stored verification data is recognized, and the document (3) is rejected.
A further embodiment, if the received and generated codes (3.8) and (3.7) are verified and match, then server (2) will respond (107) by sending the Meta data over secure internet connection to the application (5.2) or the web site (5.1) in the device (5) of the verifier (4),
The verifier (4) compares the Meta data received from server 2 and displayed on the screen of device (5) with the corresponding data provided on the document (3) (108),
An embodiment of the previous bullet, if any discrepancy is detected between the Meta data received from server (2) and displayed on the screen of device (5) and the data provided on the document (3), then document (3) is rejected and a warning of counterfeit attempt is made and recorded in an appropriate place (109),
A further embodiment of the previous bullet, if no discrepancy is found the received Meta data and the data provided by the document (3) then the document (3) Meta data is verified and validity is authenticated (110),
The verifier (4) verifies the authenticity of the rest of the document (3), which includes non Meta data, by demanding from server (2) a PDF file or a photo copy of the document (3) to be transferred over secure internet connection to application (5.2) or the web site (5.1) on device (5)(111),
The verifier (4) compares the document (3) with the received PDF file or photocopy of the document (3) and establishes the authenticity of the document (3) if no discrepancies are detected. Alternatively, if discrepancies are detected, then the document (3) is rejected and a counterfeit attempt is declared.
If the verifier (4) falsely attempts to use another method for the verification of the document by means of scanning the document (3) and applying image processing techniques, then the verification code (3.6) will prevent such attempt
An embodiment of the previous bullet is that the verification code (3.6) is added to the document with noise in order to prevent auto scanning, and thus will not be verifiable by auto scanners and image processing techniques or optical character readers.
An embodiment of claim #7 is that the verification operation detects seven (7) types of counterfeit attempts as listed below
1—Physical fabrication of document (3), where document (3) was never issued by the issuing organization (2)
2—Physical alterations of any part of the Meta data present on the document (3)
3—Physical alterations of any part of the data other than the Meta data present on the document (3)
4—Electronic alterations of the Meta data of document (3) on the server database 2 (6.1)
5—Electronic alterations of the non Meta of document (3) on the server database 2 (6.1)
6—Simultaneous alterations of the physical data of document (3) and the electronic data on the server database 2 (6.1)
7—Any attempt to verify the authenticity of a counterfeit document without using the proper method described in this invention.

8. It is the verification method of a system (1) in claim 7 that is used for the verification of the documents online and in real-time with a unique code (3.8) and (3.7) and (3.6) and detects seven (7) types of counterfeit attempts as listed below:
Physical fabrication of document (3), where document (3) was never issued by the issuing organization (2)
Physical alterations of any part of the Meta data present on the document (3)
Physical alterations of any part of the data other than the Meta data present on the document (3)
Electronic alterations of the Meta data of document (3) on the server database 2 (6.1)
Electronic alterations of the non Meta of document (3) on the server database 2 (6.1)
Simultaneous alterations of the physical data of document (3) and the electronic data on the server database 2 (6.1)
Any attempt to verify the authenticity of a counterfeit document without using the proper method described in this invention.

9. It is the invention claim #8 which provides is a method for collecting real-time statistics regarding the verification of the document (3) being verified by verifier (4).
It is an embodiment of claim 9 that the verifier (4) must have registered on the verification system
It is further embodiment that the registration of the verifier (4) must be validated by the authentication and verification system and the issuer (2)
It is another embodiment of claim #8 that documents and document bearer can be traced based on the verifier identity and location

10. The invention is the authentication method of a system (1) which is used to authenticate documents online and in real-time by generating a unique code (3.8), a 16 hexadecimal digit code (3.7) and a verification code (3.6) and used for authenticating the document (3) with the unique codes (3.8), (3.7) and code (3.6) and prevents counterfeiting the documents issued by the organizations and academic institutions as well as all official and private organizations through an integrated online and real-time process and it includes the following steps.
Document issuer (2) submits meta data of the document (3) to (2.1) code supplier service application in Server 1 (2.1) through secure communication and network tools while document (3) is being generated and requests unique codes (3.8) and (3.7) and the KAPTCHA code (3.6) (90), {The KAPTCHA code is a randomly generated 5 digit code written in a skewed and noisy format to prevent auto scanning}.
The code supplier service application 1 (2.1) generates the unique code (3.8) consisting of two independent codes, one is related to the meta data of the document (3), and the other is related to data of the document issuer (2) (91),
It is an embodiment that the code supplier service application (2.1) sends the generated codes (3.8), (3.7) and (3.6) to the document issuer (2) through secure internet connection.
The unique code (3.8) generated is placed in the document (3) and integrated with the QR code (3.1), NFC (near field communication) (3.2), optical medium strip (3.3), magnetic medium strip (3.4) or radio frequency identification (3.5) (92).
Subsequently, we will assume that the code (3.8) is embedded within a QR code (3.1) without loss of generality.
The 16 hexadecimal digit code (3.7) (to be used for verification of the document (3) over the web site (5.1)) is generated together with the unique code (3.8) and is placed on the document(3) in a visible format (93),
The code supplier service application (2.1) generates a verification code (3.6) consisting of 5 random characters/digits (94), and is placed on document (3) in a KAPTCHA format, such that the code (3.6) cannot be used by a robotic application, an auto scanner, or an image or character processing software.
The document issuer (2) receives and verifies the codes generated for the document (3), and adds the code (3.8) in a QR embedded format, and the 16 hexadecimal digit code (3.7) and the verification code (3.6) to the document (3).
The document issuer (2) generates a PDF file for document (3) and/or a photocopy of document 93).
The document issuer (2) Transfers immediately the PDF file and/or the photocopy of document (3) to the verification server 2 (6.1) (95).
The verification server 2 (6.1) stores and saves the followings for the document (3)
a. The PDF file and/or the photocopy of the document (3)
b. The Meta data of the document
c. The three codes generated for the document (3.6), (3.7), and (3.8)
Claim #9 is an independent claim

11. It is the invention claim #10 that enables the issuer (2) of document (3) to control the validity of the document (3) and to augment document (3) with annotations after the document (3) has been issued and properly authenticated.
It is an embodiment of this claim that the issuer (2) has access to the document data on the verification server (2.1)
It is a further embodiment of claim #11 that the document (3) record in the database can be either valid or invalid. And the issuer (2) of the document is the only entity, which controls this field.
The issuer (2) may convert the document (3) from valid to invalid or vice versa from invalid to valid for any reason established by the issuer.
By the same procedure, the issuer (2) can set or reset an expiration date of the document (3)
A further embodiment of this claim is that the physical document (3) does need to be modified or reissued for the purposes of resetting expiration dates, invalidation, or cancelling.

12. It is the invention claim #10 which provides a method for collecting real-time statistics regarding the documents (3) being authenticated by issuer (2).
